(19) United States
(12) Patent Application Publication
(10) Pub. No.: US 2002/0124257 A1
(43) Pub. Date: Sep. 5, 2002

(54) Order-delivery service system via interactive systems

(76) Inventor: Radik Ismagilov, Anchorage, AK (US)

Correspondence Address: Radik Ismagilov, 4200 Artesia Blvd. #43, Torrance, CA, 90504, US

(21) Appl. No.: 09/800,556

(22) Filed: Mar. 5, 2001

(51) Int. Cl. H04N 7/173; H04N 5/445

(52) U.S. Cl. 725/60; 725/68; 725/37; 725/131

(57) ABSTRACT

Order-delivery service via interactive systems (TV set with cable box or satellite dish network, Wireless or Pro/Wireless, PDAs, handhelds, pocket PCs) providing customers with access to menus of fast food restaurants, other restaurants and dining places and ability to order and receive a fast delivery using a remote control device for a TV set, cable box, or satellite dish network box.

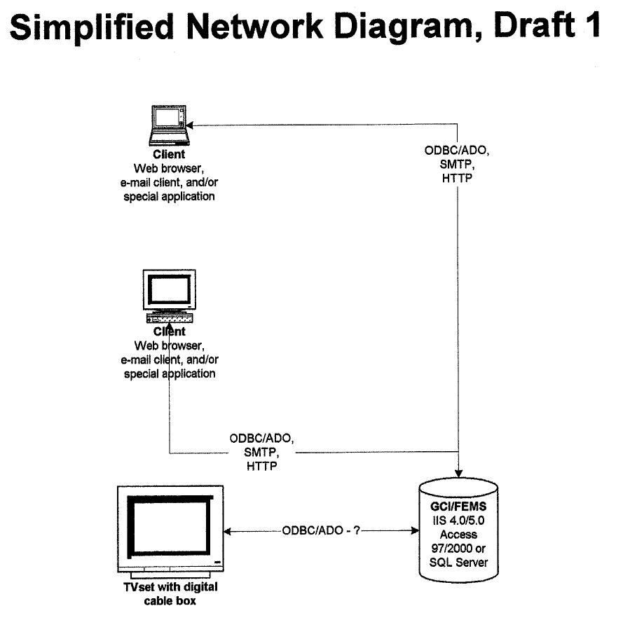

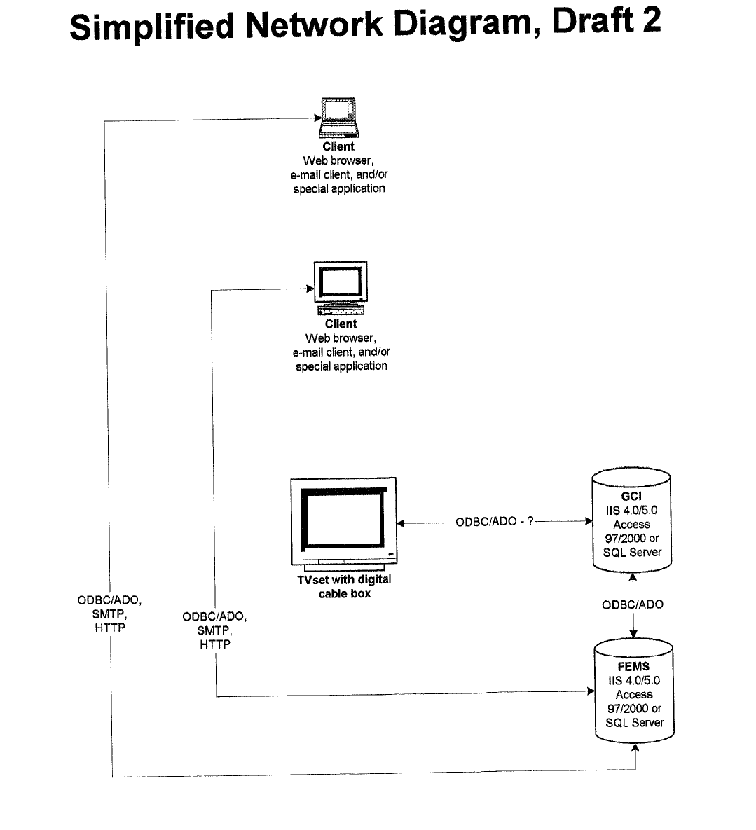

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to the “Delivery” field. It provides the more convenient and fast access to menus of fast food restaurants, other restaurants and dining places, that allows receiving a faster delivery for potential customers.

I had numerous talks with GCI, which provides an interactive system in Alaska, and fast food restaurants, such as Pizza Hut and KFC. All parties were very interested in this invention. Now we are working with these companies on implementing this invention in Alaska. After successful implementation in Alaska, we plan to extend it to the other states and countries.

### BRIEF SUMMARY OF THE INVENTION

The general idea is to provide a service, which will connect people with fast food restaurants, other restaurants and dining places via TV set interactive systems using a remote control to make an order.

Advantages:

access to more customers because more and more people are using interactive systems providers for their TV sets;

easier access to the system in comparison to the on-line internet delivery and waiting time on the phone;

more convenient for customers and fast food restaurants and other restaurants and dining places;

fast interaction between customers and fast food restaurants and other restaurants and dining places (results in faster delivery).

### BRIEF DESCRIPTION OF THE SEVERAL VIEWS OF THE DRAWING

Diagram “Draft 1” shows a process flow if our company uses the same database and server(s) with the provider of the interactive system.

Diagram “Draft 2” shows a process flow if our company and the provider of the interactive system use the separate database and server(s).

### DETAILED DESCRIPTION OF THE INVENTION

The general idea is to provide a delivery service, which will connect people to the fast food restaurants, other restaurants and dining places via TV set interactive systems. A potential customer will do it by pressing the buttons on the remote control to make a choice from the menu and confirm the order for the delivery.

Our company will use an interactive system provider database and server(s) or we will use our database and server(s) connected to the interactive system provider's database and server(s). We will also connect our database to the fast food restaurants, other restaurants and dining places. This way, a potential customer will have an access to the menus of the fast food restaurants, other restaurants, and dining places. We will have an access to the customer specific information such as name, address, phone number, etc. As well, we will have an access to the fast food restaurants, other restaurants, and dining places databases. This way we can transfer specific information such as what and where to deliver and to whom. The fast food restaurant or another restaurant or dining place closest to the customer will provide a delivery service and collect payment.

Working process:

1) Customer will have an ability to see on the TV screen the menu of the interactive service provider with logos or signs of the fast food restaurants, other restaurants, and dining places, which are our customers.

2) By pressing the buttons on the remote control, a customer will choose a menu of the specific restaurant.

3) Doing this a customer will have an ability to order the products (by pressing products choice from the menu) and confirm the order for the delivery.

4) Then a customer can go out of the restaurant's menu and watch any program he/she wants.

5) A customer's order will go to the interactive system provider's database (with our database connected to it) and automatically to the screen in the specific restaurant (with the specific information about the customer).

6) The fast food restaurant or another restaurant or a dining place will send its delivery person to the customer with the processed order.

7) The customer will get the order and pay for the service.

1. What I claim as my invention is an order-delivery service via interactive systems (TV set with cable box or satellite dish network, Wireless or Pro/Wireless, PDAs, handhelds, pocket PCs) that will allow potential customers to access menus of fast food restaurants, other restaurants and dining places, order and receive a fast delivery using a remote control device for a TV set, cable box, or satellite dish network box.
